(19) United States
(12) Patent Application Publication
(10) Pub. No.: US 2014/0021270 A1
(43) Pub. Date: Jan. 23, 2014

(54) VAPOR CAPTURE AND RELEASE SYSTEMS

(71) Applicants: William A. MacCrehan, Gaithersburg, MD (US); Michele M. Schantz, Gaithursburg, MD (US); Stephanie M. Moore, Chapel Hill, NC (US)

(72) Inventors: William A. MacCrehan, Gaithersburg, MD (US); Michele M. Schantz, Gaithursburg, MD (US); Stephanie M. Moore, Chapel Hill, NC (US)

(73) Assignee: National Institute of Standards and Technology, Gaithersburg, MD (US)

(21) Appl. No.: 13/923,534

(22) Filed: Jun. 21, 2013

Related U.S. Application Data
(60) Provisional application No. 61/673,361, filed on Jul. 19, 2012.

(51) Int. Cl. B65D 77/00; B01F 1/00

(52) U.S. Cl. CPC B65D 77/00; B01F 1/0005
USPC 239/10; 220/501

(57) ABSTRACT

Systems for selectively capturing and/or releasing particular vapors or odors are described. The systems utilize polymeric substrates such as in the shape of disks that can be infused with one or more target vapors or odors. The systems also utilize enclosures having one or more defined orifices. After placement of infused polymeric substrates within the interior of an enclosure, target agents evaporate or otherwise vapor transfer from the interior of the enclosure through the defined orifice(s) in a controlled and quantifiable manner.

### CROSS REFERENCES TO RELATED APPLICATIONS

This application claims priority from U.S. provisional application Ser. No. 61/673,361 filed on Jul. 19, 2012.

### FIELD

The present subject matter provides systems and related methods for the capture, storage, and/or transfer of vapors or odors of evidentiary materials for evaluation.

### BACKGROUND

The reliable generation of chemical vapors is critical to a wide variety of measurements. The detection of terrorist bombs, drugs-of-abuse, and formaldehyde in buildings are examples in which vapor sensing (either with electronic detectors or trained canines) may be optimized through training and use of a vapor generator. Although devices are known for vapor generation utilizing airflow, these are not useful in still air and require prior knowledge of the vapor components.

Odor infused explosive or drug samples have been used as canine training aid materials. However, the use of such samples requires significant efforts and is costly. For example, Customs and Border Protection maintains multiple training and certification centers in geographically diverse locations. Each location needs a source of actual samples of drugs-of-abuse and explosives. For the detection of conventional explosives, two trained bomb technicians are required for the transport of the materials to a secure explosive magazine bunker at the training site. A certified technician logs in the samples and provides documentation as to the identity and quantity of materials which are removed for training/certification exercises. Once the materials are considered expired they must be destroyed. Significant costs and efforts are associated with maintaining, storing, and after an expiration period, destroying the materials. Additional costs and undertakings are also required to maintain records, dates, and other information pertaining to the materials and their use. The undertakings are more significant and complex for improvised explosives. Currently, the Federal Bureau of Investigation (FBI) and the Bureau of Alcohol, Tobacco, Firearms and Explosives (ATF) provide canine training materials for the peroxide explosives TATP (triacetone triperoxide) and HMTD (hexamethylene triperoxide diamine) which are typically associated with improvised explosives. A trained bomb technician must transport these materials to multiple training sites throughout the U.S., resulting in a significant logistical undertaking between agencies.

Accordingly, in view of these and other reasons it would be beneficial to provide new systems and strategies by which these extensive efforts and relatively high costs can be reduced in providing odor or drug samples for evaluation and/or training.

### SUMMARY

The difficulties and drawbacks associated with previously known practices are addressed in the present systems and methods for vapor capture and release.

In one aspect, the present subject matter provides a system for selectively storing and releasing one or more target agents. The system comprises an enclosure including a wall that defines at least one defined orifice. The enclosure also defines a sealed interior for which the defined orifice provides flow communication between the interior of the enclosure and the enclosure exterior. The system also comprises a polymeric substrate sized and shaped to be positionable within the interior of the enclosure. The polymeric substrate includes a non-crystalline, hydrophobic polymer able to absorb at least one target agent for subsequent storage and/or release from the substrate. Upon infusion of the polymeric substrate with the at least one target agent, and positioning of the polymeric substrate within the interior of the enclosure, the target agent volatilizes from the substrate into a vapor phase in the interior of the enclosure and subsequently flows through the at least one defined orifice thereby exiting the interior of the enclosure.

In another aspect, the present subject matter provides a method of selectively providing at least one target agent in vapor phase. The method comprises providing a polymeric substrate that includes a non-crystalline, hydrophobic polymer. The method also comprises infusing the polymeric substrate with at least one target agent. The method also comprises providing an enclosure defining a sealed interior and at least one defined orifice in a wall of the enclosure. The method additionally comprises positioning the polymeric substrate infused with the at least one target agent within the enclosure, whereby the target agent volatilizes from the infused polymeric substrate and flows through the at least one defined orifice of the enclosure, thereby selectively providing the target agent in vapor phase.

In yet another aspect, the present subject matter provides a method for providing at least one target agent in vapor form representative of a material of interest. The method comprises identifying at least one target agent which is representative of a material of interest. The material of interest includes the at least one target agent and additional agents. The method also comprises infusing the polymeric substrate with at least one target agent. The method additionally comprises positioning the infused polymeric substrate within an enclosure having a sealed interior and at least one defined orifice in a wall of the enclosure, whereby the at least one target agent vapor transfers from the infused polymeric substrate through the at least one defined orifice of the enclosure thereby providing the at least one target agent in vapor form representative of the material of interest.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

FIG. 1 is a schematic illustration of a system providing an enclosure having a defined orifice and a vapor infused disk in accordance with the present subject matter.

FIG. 2 is a schematic illustration of an enclosure wall defining a plurality of defined orifices.

FIG. 3 is a schematic illustration of another enclosure wall defining a plurality of defined orifices.

FIG. 4 is a schematic illustration of another system having an enclosure with defined orifices and a vapor infused film in accordance with the present subject matter.

FIG. 5 is a schematic illustration of another system having an enclosure with defined orifices and a vapor infused film in accordance with the present subject matter.

FIG. 6 is a graph of vapor release profiles for three agents over time.

FIG. 7 is a graph of accumulation of an agent into the polymer via vapor phase transfer in a closed container.

FIG. 8 illustrates extraction profiles of various agents collected from a mixture of explosive formulations.

FIG. 9 is a graph of vapor release profiles for an agent on various substrates.

FIG. 10 is the profile of an agent remaining in an infused disk as vapors are released over time.

FIG. 11 is the profile of another agent remaining in an infused disk as vapors are released over time.

### DETAILED DESCRIPTION OF THE EMBODIMENTS

Many types of evidence in forensic investigations rely on the characterization of volatile components in a questioned sample. Typical examples include the detection and identification of drugs-of-abuse, explosives, and flammable liquids evaluated for arson using both instrumental analysis and canine detection.

The present subject matter provides a unique ‘capture and release’ technology that has wide applicability for the collection, archival, and release of forensic vapors/odors. An important application of the present subject matter is in the development of training materials for canine detection of drugs and explosives. As previously described, currently, canines are trained and certified using actual materials of interest such as drugs and explosives, which require secure storage and chain-of-custody documentation. In the case of explosives, specialized storage magazines and certified bomb technicians are needed for transport and maintenance of materials. This is very costly.

In one aspect of the present subject matter, a polymeric article is provided which is infused with target odors which are representative of, and/or indicative of one or more actual hazardous materials of interest, such as for example drugs or explosives. In certain versions of the present subject matter, the polymer is polydimethylsiloxane (PDMS). As explained in greater detail herein, the article can be in a wide array of shapes and forms. In many embodiments, the polymeric article is in the form of a disk or film filling the bottom of the training aid container.

The polymeric disk, for example, can be infused by several techniques such as for example by: (1) blending the target odors or vaporous component(s) with the disk monomer(s) before polymerization; (2) ‘spiking’ the target odors or component(s) directly on the disk from a volatile solvent; (3) allowing the polymer to absorb volatile target odors or component(s) by storage while exposed to the vapors of the target material without contact; and/or (4) allowing the polymer to absorb target odors or component(s) by exposure to liquid solutions that contain the target odors or components. It is also contemplated that combinations of these techniques could be used. The polymeric article may then be used to provide a slow, steady release of the volatile component(s) without the use of the hazardous material. For example, the odorants that have been shown to be characteristic of plastic explosives (2,3-dimethyl-2,3-dinitrobutane (DMNB), 2-ethylhexanol, and cyclohexanone) and the improvised volatile explosive TATP (triacetone triperoxide) can be infused into polymeric disks as described herein and selectively and subsequently released for detection. The present subject matter is not limited to single components or agents. Direct vapor transfer from complex samples such as formulated explosives has been demonstrated. Prior knowledge of the composition of the sample is not required to capture and/or release complex vapor or odor profiles. Infused disks may be used for canine training. Infused disks may also be applicable to instrumental vapor detection methods. Since the vapor profile of the sample may be captured in a robust manner, it may be stored or archived for future analysis when the time or technology becomes available for further investigation.

Currently, real controlled and/or hazardous substances must be handled using extraordinary and expensive means. The present subject matter capture and release technology provides an effective strategy to capture and record the vapor/odor profile of an evidentiary sample or canine training material. Once the vapors/odors have been captured in the polymeric disk, the disk may be used in a variety of different manners. In one version of the present subject matter, the disk is used as a vapor or odor source for the training and certification of canines used to detect contraband or for the validation of electronic sensors, instruments, or “sniffers” as known in the art. In another version of the present subject matter, the polymeric disk is infused with one or more target vapors or odors to archive the vapor profile of the sample for later evidentiary evaluation, thereby effectively providing a specimen bank sample for a specific piece of evidence. These and other aspects of the present subject matter are described in greater detail herein.

### Polymeric Substrate

As noted, the present subject matter provides a polymeric substrate or article which upon infusion with one or more agents of interest or “target agents” serves to capture, store, and/or transfer the target agents for evaluation or other use. Although the polymeric substrate is generally described herein as being in the shape of a disk, it will be appreciated that the present subject matter includes the use of a wide array of other shapes and configurations. For example, the polymeric substrate could be in the shape of a sphere, a planar sheet or flat member, or in a form of a plurality of members or components such as a collection of microspheres. However, in many applications a disk shape is useful and convenient.

The polymeric substrate can include a wide array of polymers. In many applications a particularly useful polymer is a non-crystalline, hydrophobic polymer to provide subsequent uniform release of the vapor components. One polymer, polydimethylsiloxane (PDMS) has a number of unique properties that render that polymer well suited to the incorporation of vapor components. By virtue of its hydrophobic properties, vapor components spontaneously absorb into the polymer matrix. Being a non-crystalline, gel-like polymer, PDMS provides “liquid-like” transport properties. Favorable transport within PDMS facilitates accumulation of the vapor component(s) and also their uniform release back into the vapor phase. PDMS is a polymer that is easily cast at room temperature. Once polymerized using a typical two component mixture, the polymer has high thermal stability and may be heated to 200° C. or higher to remove any vaporous impurities.

As noted, a number of approaches can be used to infuse the polymer such as PDMS with vaporous components. Hydrophobic compounds that are liquids or easily melted solids may be directly mixed with the monomer before polymerization. Alternatively, components may be infused from solution. In many versions of the present subject matter, PDMS may be infused by suspending the polymeric article in a closed container over a sample that releases vapor component(s) for accumulation, i.e., vapor infusion without direct contact with the sample. After a period of days to weeks for example, the PDMS becomes infused with the volatile components. Once infused, the PDMS sample releases a slow controlled amount of vapor components, mimicking the vapor profile of the target substance. The release rate may be controlled in a quantitative manner by allowing the sample to be open to the atmosphere through one or more defined orifice(s) as described in greater detail herein. With such a protocol, a steady release of vapors may be sustained for 70 hours or more. Vapor infusion of the PDMS provides a significant advantage in that prior knowledge of the characteristic vapor compounds of complex samples (such as formulated mixtures such as plastic explosives, or natural products such as cannabis) is not necessary for the preparation of a controlled release sample. PDMS infusion renders explosives inert and makes the physiologically-active components in drugs unavailable for ingestion. In addition, the PDMS matrix has been shown to provide long term stability for the highly volatile and unstable compound triacetone triperoxide (TATP).

In certain embodiments of the present subject matter, one or more commercially available grades of PDMS can be used. For example SYLGARD 184 available from Dow Corning can be used. That grade of material includes a volatile impurity, e.g., ethyl benzene. In order to remove many if not all volatile impurities from the polymeric substrate a heating or baking operation can be performed. For example, a polymeric substrate such as the noted SYLGARD 184 material can be baked at 200° C. for four hours. Such heating renders the material suitable for use in the present subject matter, and particularly for receiving one or more target vapors by direct vapor infusion or solvent soaking methods. Another suitable grade of PDMS which is commercially available is 93-500 Space Grade from Dow Corning. That material is free of any volatile organic compounds and therefore does not require a heating or baking operation.

The present subject matter includes incorporating the polymeric substrate in the interior of the enclosure in a variety of configurations and techniques. In one version, a film of the polymer of interest can be formed or otherwise disposed on an interior face or region of an interior wall or other portion of the enclosure. For example, a polymeric film can be directly cast on a bottom or bottom wall of an enclosure. However, it will be appreciated that the present subject matter includes a wide array of incorporation strategies of polymeric substrates or films within interiors of enclosures.

Another feature of the present subject matter polymeric substrates is that the substrates such as in the form of a disk, need not contact the sample(s) containing the target agents. Instead, the polymeric substrate accumulates the volatile target agents by vapor phase transfer and thus does not incorporate irrelevant compounds such as those associated with many hazardous explosives. In this aspect of the present subject matter, after infusion of the polymeric substrate with one or more target agents, the polymeric substrate may be free of other additional and typically irrelevant agents. Target agents or other odorants could also be infused or otherwise transferred to the polymeric substrate by soaking or immersing the polymeric substrate in a solution of the odorant dispersed in a liquid vehicle or solvent. During such soaking or immersion, the target agent(s) or odorant(s) are transferred to the polymeric substrate by absorption. These practices have been found to promote uniform release rates or release profiles of the target agent(s) from the polymeric substrate.

### Enclosures with Defined Orifice(s)

The present subject matter also provides enclosures for receiving and containing the polymeric substrate(s) that are infused with one or more target agents. The enclosures include a wall or other region that defines one or more orifices which permit passage or transfer of the target agents within the enclosure to an external environment or to an instrument or biological sensor, e.g., a canine. The enclosures typically define a sealed interior but for the orifice(s). The enclosures also typically include one or more access panels, doors, or the like to provide selective access to the interior of the enclosure such as when placing or replacing polymeric disks therein. Polymer films may also be cast in the bottom of the training aid container. It may be possible to “recycle” spent training aids by baking out the odorants and reabsorbing target vapor compounds.

The enclosures of the present subject matter may be in a wide variety of shapes, sizes, and configurations. In certain versions of the present subject matter, the enclosure is in the shape of a cylinder with a sealed but removable circular cap at one or both ends. One or both cap(s) can include one or multiple defined orifices. Other enclosures are contemplated such as flexible wall enclosures.

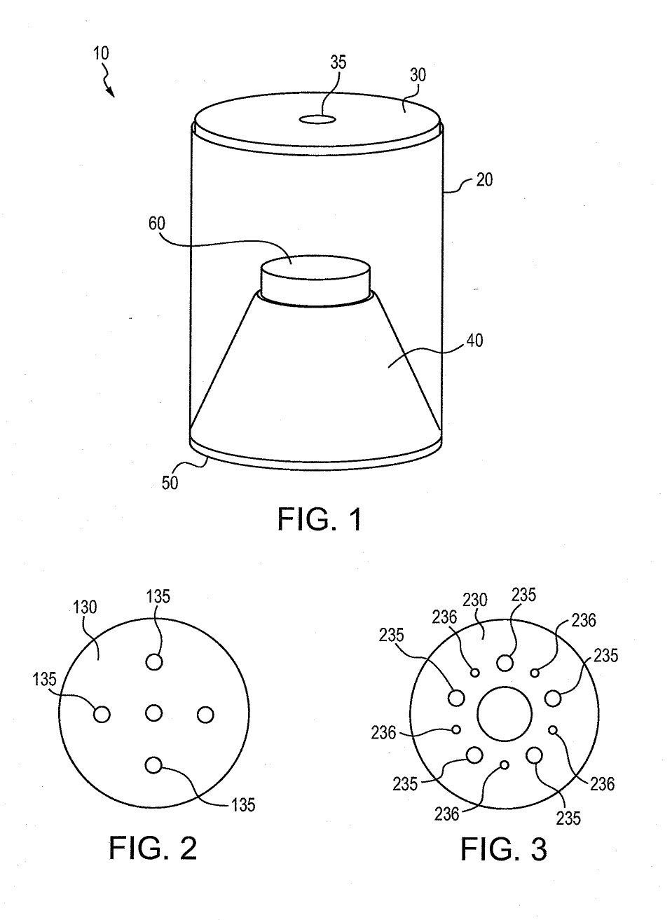

FIG. 1 is a schematic illustration of a system 10 comprising an enclosure 20 having a defined orifice 35 and a vapor infused disk 60 contained therein, in accordance with the present subject matter. The enclosure 20 includes a first end 30, a second end 50, and a circumferential wall extending between the ends. The enclosure is sealed so as to define a sealed interior that is accessible exclusively via the defined orifice 35. As explained in greater detail herein, the orifice is a “defined orifice”. That term as used herein refers to the orifice having an opening or aperture of known geometry, i.e. area available for gas or vapor flow therethrough. The enclosure 20 may also include a base or support region 40 located within the sealed interior of the enclosure. The support region 40 can for example be in the form of a raised platform sized and configured to support one or more polymeric disks or other articles within the interior of the enclosure 20. Although the enclosure 20 is depicted in FIG. 1 as having a cylindrical shape, it will be appreciated that the present subject matter includes the use of a wide array of other shapes. For example, the enclosure can be spherical, cubical, polysided, or utilize one or more regions of flexible wall material.

As noted, the enclosure includes one or more defined orifices. Thus, the enclosure can utilize a single orifice such as shown in FIG. 1. Or, the enclosure can include multiple orifices such as depicted in FIGS. 2 and 3. Specifically, FIG. 2 illustrates an enclosure end 130 defining a plurality of defined orifices 135. In this version of the present subject matter, the orifices 135 are typically symmetrically arranged along a face of the end 130. When utilizing multiple orifices, the orifices can all have the same size and/or shape such as shown in FIG. 2. Alternatively, the orifices can have different sizes and/or shapes so long as each orifice is a defined orifice. FIG. 3 illustrates an enclosure end 230 defining a first population of defined orifices 235 and a second population of defined orifices 236. It will be appreciated that the present subject matter includes a wide variety of orifice shapes, sizes, arrangements and configurations.

In certain versions of the present subject matter, the enclosure includes one or more defined orifices at select locations and/or within particular regions of the enclosure. For example, in particular applications the enclosure defines one or more defined orifices in sidewalls or laterally directed regions of the enclosure. Such sidewall orifices can be provided in a designated pattern, ordered or repeating pattern, or in a random arrangement. The one or more sidewall orifices can be provided in combination with one or more orifices defined in an upwardly directed wall or top region of an enclosure. Alternatively, all defined orifices in an enclosure can be sidewall orifices. It will be appreciated that the present subject matter includes a wide array of orifice locations, combinations of locations, arrangements and numbers.

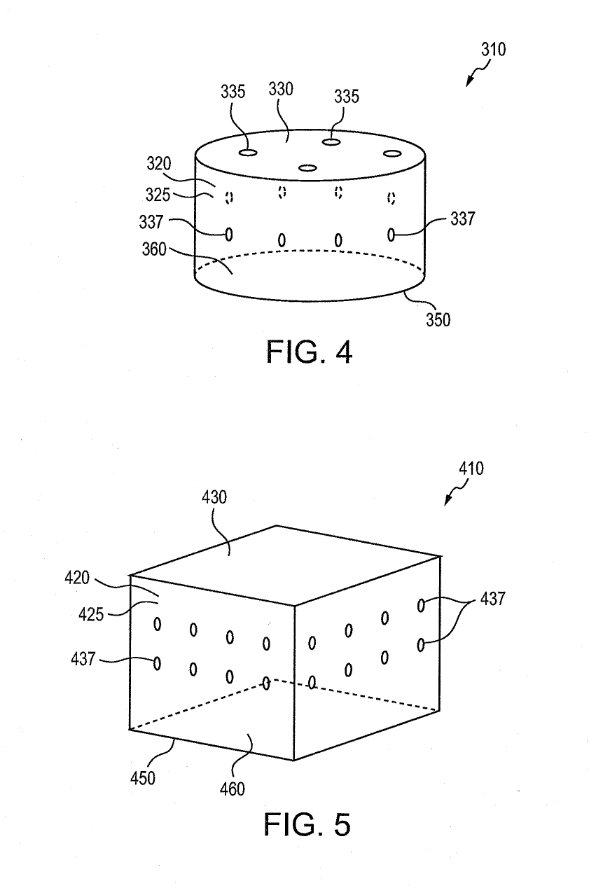

FIGS. 4 and 5 schematically illustrate additional systems 310 and 410 in accordance with the present subject matter. The system 310 depicted in FIG. 4 comprises an enclosure 320 having a plurality of defined orifices 335 and 337 and a vapor infused film 360 contained therein. Although the vapor infused film 360 is shown as deposited or disposed upon the bottom end 350, it will be appreciated that the present subject matter includes a wide variety of locations and placement configurations of the film 360 within the enclosure 320. The enclosure 320 includes a first or top end 330, a second or bottom end 350, and a circumferential wall 325 extending between the ends 330 and 350. The enclosure 320 is sealed so as to define a sealed interior that is accessible exclusively via the defined orifices 335 and 337. As specifically shown in FIG. 4, the enclosure 320 defines a plurality of defined orifices 335 in a top or endwall, i.e. 330, of the enclosure in combination with a plurality of defined orifices 337 in a sidewall, i.e. 325, of the enclosure.

FIG. 5 schematically illustrates another system 410 in accordance with the present subject matter. The system 410 comprises an enclosure 420 having a plurality of defined orifices 437 in only sidewalls of the enclosure. The system 410 also comprises a vapor infused film 460 contained therein. The film 460 can for example be provided along an interior face or region of a bottom wall 450 of the enclosure 420. However, the present subject matter includes other locations of the film 460 within the interior of the enclosure 420.

It will be understood that the present subject matter also includes the provision of one or more defined orifices in enclosures having geometries or shapes different than those depicted in the referenced figures.

Although not wishing to be bound to any particular theory, the enclosures depicted in FIGS. 4 and 5 may be beneficial for vapors or odors that have vapor densities greater than air. That is, for such relatively “heavy” vapors, egress from the enclosure is facilitated by providing sidewall defined orifices as compared to an enclosure having defined orifice(s) in only a topwall of the enclosure.

In certain embodiments of the present subject matter, one or more of the defined orifice(s) include a selectively positionable gate adjacent the orifice that can be positioned to cover or prevent passage of gas, vapor and/or air flow through the orifice(s). That is, the selectively positionable gate can be used to open or close one or more aperture(s). The selectively positionable gate can also be used to adjust the size of the orifice, i.e. the cross sectional area for flow through the orifice.

The shape, style, size, and configuration of the defined orifice(s) is not critical so long as the size and access parameters, e.g. flow cross sectional area, are known or quantifiable. Generally, larger orifices will provide higher release rates of vaporous target agents and smaller orifices will provide lower release rates. For circular shaped orifices, a wide range of diameters is contemplated. For example, diameter of a defined orifice may range from about 0.5 mm to 50 mm, with 4 mm to 12 mm being typical. It is also contemplated that a plurality of orifices can be provided which vary in size. Moreover, one or more orifice(s) of a plurality of orifices could be sized so as to be optimized for a particular target agent of interest. For example, highly volatile target agents would need less orifice opening size as compared to low volatility target agents. The sum of the opening sizes of all orifices of the plurality of orifices would be determined based upon the amount (or rate of release) of vaporous target agents necessary to elicit a positive response such as from a canine.

Upon infusion of the polymeric substrate with one or more target agents and positioning of the polymeric substrate within the interior of the enclosure, the target agent can volatilize from the substrate into a vapor phase within the interior of the enclosure and subsequently flow through the one or more defined orifice(s) and thereby exit the interior of the enclosure. In certain applications, the temperature of the system, e.g. the enclosure and the polymeric substrate will be greater than the boiling point of the target agent(s). Thus, the target agent(s) readily transform to a vapor phase in their egress or flow from the enclosure. However, the transfer of a target agent can also occur at a temperature less than the boiling point of the agent. As is known, agents may volatilize or sublimate to a vapor at temperatures less than the boiling point of the agent.

### Methods

The present subject matter also provides various methods. In one embodiment, the subject matter provides a method of selectively providing at least one target agent in vapor phase. The vaporous target agent could be used for subsequent training or analysis. The method comprises providing a polymeric substrate that includes a non-crystalline, hydrophobic polymer. The method also comprises infusing the polymeric substrate with at least one target agent. Infusion can be accomplished in a wide variety of techniques as noted herein. The method also comprises positioning the polymeric substrate infused with the at least one target agent within an enclosure. The enclosure has a sealed interior and at least one defined orifice in a wall of the enclosure. The target agent volatilizes from the infused polymeric substrate positioned in the enclosure and flows through the at least one defined orifice of the enclosure thereby selectively providing the target agent in vapor phase.

In certain aspects, infusing the polymeric substrate with at least one target agent is performed by combining the at least one target agent with one or more monomers of the polymeric substrate prior to polymerizing the monomers to form the polymeric substrate. In other aspects, infusing the polymeric substrate with at least one target agent is performed by vapor phase transfer from a source material containing the target agent to the polymeric substrate. And, in additional aspects, infusing the polymeric substrate with at least one target agent is performed by contacting the polymeric substrate with the target agent in a volatile solution.

In other embodiments, the subject matter relates to methods of providing one or more target agents in vapor form which are representative of a material of interest. For example, a material of interest may be a drug-of-abuse or an explosive. The method comprises identifying at least one target agent which is representative of a material of interest. Typically, the material of interest such as a hazardous material, e.g. drugs-of-abuse, explosives, or flammable materials, includes the one or more target agents and controlled agents, toxic agents, additional agents. The method also comprises infusing a polymeric substrate with the one or more target agents. Infusion can be performed by any of the techniques described herein. The method also comprises positioning the infused polymeric substrate within a sealed enclosure having one or more defined orifices as described herein. The one or more target agents transfer in vapor phase (also referred to herein as “vapor transfer”) from the infused polymeric substrate through the at least one defined orifice of the enclosure thereby providing the one or more target agents in vapor form which are representative of the material of interest, e.g. a hazardous material.

### Additional Aspects

The present subject matter provides both a strategic advance for forensic science as well as for the development of reference materials. The ability to capture the presence of such an elusive quantity as an odor profile for subsequent release will have many forensic applications. Substitution of infused PDMS that presents the odors of controlled/hazardous substances in a non-hazardous format represents a substantial cost reduction. Laboratories and organizations which prepare canine training aid materials for drugs-of-abuse would be interested in the present subject matter odor transfer technology. In addition, infused PDMS disks may be a viable approach to provide reference materials to support the measurements of controlled/hazardous substances in a form that has been rendered inert, yet is suitable for transfer to forensic laboratories for vapor/odor evaluation.

The present subject matter has been demonstrated as useful for the capture and release of odorant chemicals known to elicit a bomb detection response from trained canines (2-ethylhexanol, DMNB, and cyclohexanone for plastic explosives, and TATP). In addition, the highly volatile and unstable TATP appears to be stabilized by infusion into the PDMS matrix. Similar results might be expected for infusing PDMS with the traditional drugs-of-abuse and the new ‘designer’ drugs such as the substituted cathinones (i.e., bath salts) and synthetic cannabinoids (marijuana substitutes). Obtaining, maintaining, and characterizing these varied and ever increasing number of illicit materials has proven to be a major hurdle for forensic agencies.

The ability to capture the odor signature obtained from actual contraband substances with a non-hazardous PDMS transfer medium would provide a significant advantage for providing canine training and certification materials. Costs to federal, state, and local forensic agencies could be greatly reduced through the availability of training aids for contraband in a non-hazardous form. Development of well characterized infused PDMS may also prove to be a method for providing Standard Reference Materials (SRMs) for the highest priority contraband materials.

The value of uniform, well characterized materials for canine training can not be underestimated. Currently, materials obtained for canine training have limited pedigree. It has been shown that the characteristic odorant profile of ostensibly identical samples of C-4 provide over an order of magnitude difference in odorant concentration. There will never be uniform, demonstrably valid canine detection of contraband without a uniform set of reference materials for training and performance assessment.

In certain aspects of the present subject matter, systems for providing one or more target agents provide such without a flowstream such as a flowing gas or vapor flow. That is, in certain embodiments of the present subject matter, one or more target agents are provided in vapor form free of any flow stream such as a flowing air stream. In this version of the present subject matter, the system or methods of providing target agents are referred to as “free of air flow”. It is believed that such delivery will be beneficial in many applications. However, will also be understood that the present subject matter also includes the use of a flow stream such as a flowing air stream to facilitate capture, transfer, and/or delivery of the one or more target agents, which is to include sniffing canines.

In many versions of the present subject matter, the polymeric substrate at least partially reversibly captures the one or more target agents. Such reversible capture and release enables the polymeric substrate and particularly the non-crystalline, hydrophobic polymers constituting the substrate, to readily bind and subsequently release the target agents. In contrast, many polymers irreversibly capture agents or other vapor components which preclude or at least substantially prevent subsequent release of the agents from the polymer.

It is also contemplated that in certain versions of the present subject matter and particularly those in which the polymer substrate is cast or otherwise formed with a portion of the enclosure, that the enclosure and polymer could be “renewed” by heating the enclosure and polymer to a temperature sufficient to drive off any infused vapors, odors, or other agents from the polymer. The renewed polymer could then be infused again with the same or with different agent(s) as desired.

The present subject matter is contemplated for use with a wide array of target agents. For example, the target agents may be agents used or characterized as, or associated with, (i) accelerants, (ii) agricultural or biological agents, (iii) contraband, (iv) explosives, (v) agents associated with human remains, (vi) narcotics, controlled physiologic substances, or illegal drugs, (vii) agents associated with pests and/or insects, (viii) other agents of interest, and (ix) combinations of any of (i)-(viii). It will be appreciated that the present subject matter is not limited to any of the noted categories or agents.

Representative and nonlimiting examples of accelerant agents include nearly any ignitable liquid such as gasoline, light petroleum distillates, medium petroleum distallates, and heavy petroleum distillates. Additional examples of typical accelerants include diesel fuel, kerosene, turpentine, butane, and other flammable solvents.

Representative and nonlimiting examples of agricultural or biological agents include certain bacterial cultures, excretions, fungi, arthropods, mollusks, plants and seeds, fruits, and/or vegetables. Parasitic plants and noxious weeds are included.

Representative and nonlimiting examples of contraband include materials used in cell phones and their components such as tantalum (coltan), niobium, battery materials, phone housing materials, currency such as paper or coins, tobacco, alcohol and particularly ethyl alcohol, narcotics (see below), prescription drugs, and explosive agents (see below) such as gun powder.

Representative and nonlimiting examples of explosives or agents associated with explosives include RDX, PETN, TNT, dynamite, black powder or other grades of gun powder, double base smokeless powder, ammonium nitrate, black powder substitutes, blasting agents, cast boosters, Composition B, explosive emulsions, nitromethane, photoflash agents, fireworks, pyrotechnic powders, plastic explosives, Semtex, single based smokeless powder, slurries containing explosive agents, Tetryl, water gel explosive agents, chlorate based mixtures such as potassium chlorate, nitrate based mixtures such as ANFO nitrate, perchlorate based mixtures such as potassium perchlorate, urea nitrate, peroxide based explosives, hexamethylene triperoxidediamine (HMTD), triacetone triperoxide (TATP), liquid explosive agents, taggants such as ethylene glycol dinitrate Semtex, dimethyl dinitro butane (DMNB), ortho-mono nitrotoluene (o-MNT), and para-mono nitrotoluene (p-MNT). Combinations of these are also contemplated. Many explosive agents can be classified by chemical structure. Table 1 set forth below lists several main classes of explosive agents and extent of detection training required by many training programs for substance detector dogs, i.e., mandatory or elective.

TABLE 1
Main Chemical Classes of Explosives, Categorized as Mandatory and Elective

| Explosive | | |
|---|---|---|
| Classes | Mandatory | Elective |
| Nitro Alkanes | None | Nitromethane (NM) |
| (C—No₂) | | 2,3-dimethyldinitrobutane (DMNB) |
| Nitro Aromatics | 2,4,6-trinitrotoluene | Dinitrotoluene (DNT) |
| (Ar—NO₂) | (TNT) | Picric acid (PA) |
| | | Tetranitro-N-methylaniline (Tetryl) |
| Nitrate Ester | Pentaerythitol tetranitrate | Methyl nitrate (MN) |
| (C—O—NO₂) | (PETN) | Nitroglycerin (NG) |
| | | Ethylene glycol dinitrate (EGDN) |
| | | Diethylene glycol dinitrate (DEGN) |
| | | Nitrocellulose (NC) |
| | | Nitroguanidine (GN) |
| Nitramines | Trinitro-triazacylohexane | Methylamine nitrate (MAN) |
| (C—N—NO₂) | (cyclonite or RDX) | Tetranitro-tetrazacylooctane (Octogen or |
| | | HMX) |
| | | Hexanitroisowurztitane (CL20) specialty |
| | | military explosive |
| Acid Salts | Ammonium nitrate (AN) | Ammonium perchlorate (AP) |
| (NH⁴⁺, NO³⁻) | Potassium nitrate (PN) | Potassium chlorate (PC) |
| | | Potassium perchlorate (PP) |
| | | Urea nitrate (UN) |
| Peroxides | None | Triacetone triperoxide (TATP) |
| (C—O—O—C) | | Hexamethylene triperoxide diamine |
| | | (HMTD) |

Representative and nonlimiting examples of agents typically associated with human remains include human blood (fresh and old), human decomposition material (such as tissue, adipocere, wet and dry bone, and body fluids), burned human tissue, and combinations of these.

Representative and nonlimiting examples of narcotic agents, controlled physiologic substances, or illegal drugs include marijuana, cocaine, heroin, methamphetamines, and combinations of these. More specifically, examples of narcotics include opium, opiates, and their derivatives, salts, and isomers, poppy straw and concentrates thereof, coca leaves, cocaine and its derivatives, salts, and isomers, and combinations thereof.

Representative and nonlimiting examples of agents associated with pests and/or insects include invasive insects such as gypsy moths, Asian long-horned beetles, hemlock Wooly adelgids, pine shoot beetles, sirex woodwasps, and emerald ash borer. Other insects are contemplated such as certain bees, ants, mites, butterflies, moths, flies such as Drosophila flies, and ticks. Examples of pests can also include certain snails and parasitic water organisms.

It is also contemplated that the present subject matter can be used for detection and/or training for detecting other target agents of interest or potential interest such as plastic objects which simulate or represent cell phones, plastic bottles or containers, sealable plastic bags, tennis balls, shaving lotions or creams, gauze, books, food items, electronic devices, and combinations of these. Many of these items or materials are restricted from correctional or other secured premises.

### EXAMPLES

In order to assess vapor-time profiles of test materials, the assignee of the present application has developed a unique metrology referred to as SPME-ESIS (Solid-Phase MicroExtraction with an Externally-Sampled Internal Standard). These analyses are described in the following publications: W. MacCrehan, S. Moore, M. Schantz, “Evaluating Headspace Component Vapor-Time Profiles by Solid-Phase Microextraction with External Sampling of Internal Standard”, Anal. Chem. 83 (201) 8560; and W. MacCrehan, S. Moore, M. Schantz, “Reproducible Vapor-Time Profiles Using Solid-Phase Microextraction with an Externally Sampled Internal Standard”, J. Chrom. A, 1244 (2012) 28. The SPME-ESIS analyses allows the determination of the vapor-time profile of samples that have been exposed to the atmosphere through measurement of an analyte to an internal standard (A/E) ratio. Plots of the A/E ratio as a function of time allow a detailed characterization of the vapor/odor profile including (under well-controlled conditions) determination of the vapor concentration.

Infusion of Vapors/Odors into PDMS

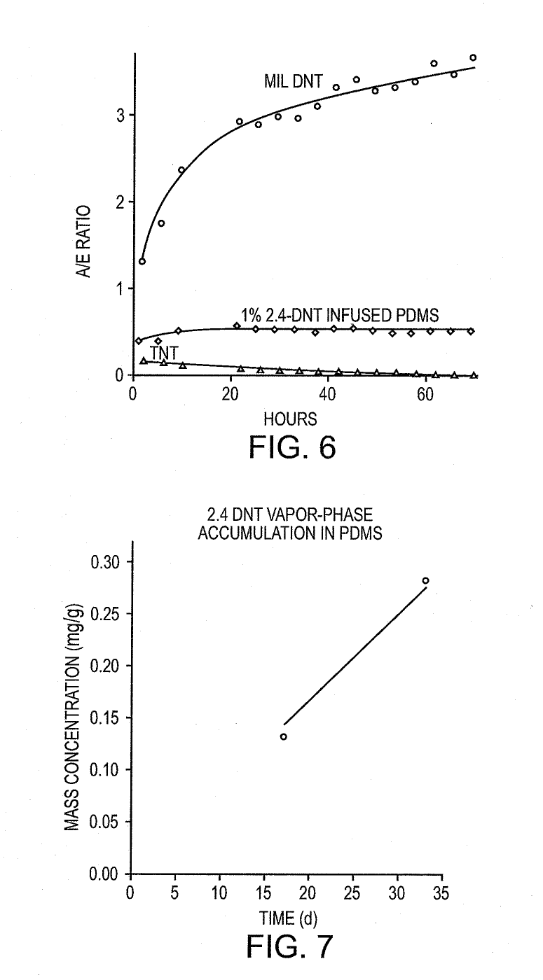

Some preliminary investigations on infusing PDMS with volatile components have been performed using three approaches: (1) dissolution of pure components directly in the PDMS monomer prior to polymerization, (2) vapor-phase transfer from the source or test material directly to the PDMS disk via storage for extended periods, and (3) direct deposit or contacting of odorants or odorant mixtures from a volatile solution. An initial goal is to further explore these approaches to infusion to optimize the process for each application. For example, the pure component 2,4-DNT (the primary odorant identified in the canine detection of the explosive TNT) was infused by melting and mixing with the PDMS monomer prior to polymerization, resulting in 1% 2,4-DNT infused PDMS. The vapor-time behavior of this material is compared to military grade 2,4-DNT crystals and to the 2,4-DNT impurity in TNT over three days in FIG. 6. Whereas the crystalline material (Mil DNT) never achieves a steady amount in the vapor phase, the infused PDMS rapidly achieves a steady vapor release. The actual crystalline TNT soon loses the ability to release notable amounts of 2,4-DNT. The vapor concentration released as a function of the amount of vapor compound infused into the PDMS may be significant in that the vapor time profile may be controlled in a predictable manner.

Also investigated was the uptake of 2,4-DNT into a PDMS disk by suspending the disk on a screen over pure 2,4-DNT crystals in a closed container for periods of time and then the disks were solvent extracted and analyzed, as shown in FIG. 7. For 2,4-DNT the vapor-phase accumulation over the period of 17 to 33 days appears to be in a linear region and did not approach saturation at the mg/g concentration range. This is an indication that the PDMS has substantial untapped capacity to absorb odorants.

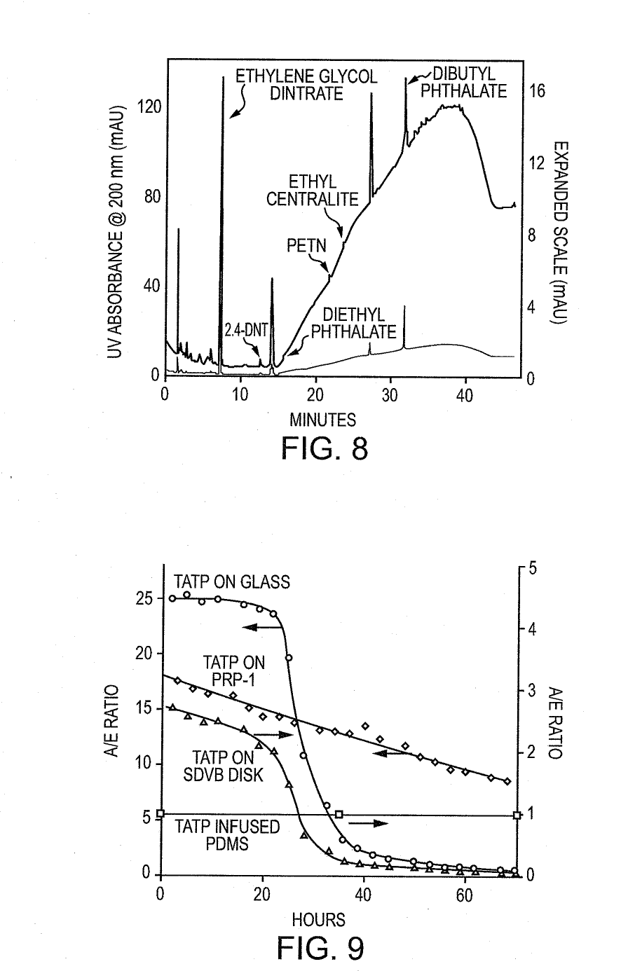

The PDMS infusion strategy also works well with complex mixtures such as with the plastic explosive Semtex. There are actually three formulations of Semtex: 1A, 10, and H. A disk was stored for 30 days while positioned over and in close proximity to a mixture of the three formulations to provide all of the odors associated with a ‘consensus’ Semtex. After extraction a number of absorbed components were identified, as shown in FIG. 8. The ethylene glycol dinitrate, 2,4-DNT, and ethyl centralite have been identified previously as key odorants that canines use to identify plastic explosives.

### Investigating the Vapor-Time Release of Infused PDMS

An important feature of the capture and release technology is the nature of the vapor-time profile for the release of the target components using the SPME-ESIS measurements. Such a study was made for a number of materials providing the terrorist explosive TATP over three days, as shown in FIG. 9. It is evident that the various materials have unique vapor-time profiles, but also that the TATP infused PDMS is the only material to provide a uniform release with time. This particular infused material was prepared by ‘spiking’ the disk with a solution of TATP in volatile solvent and allowing the solvent to evaporate before SPME-ESIS evaluation.

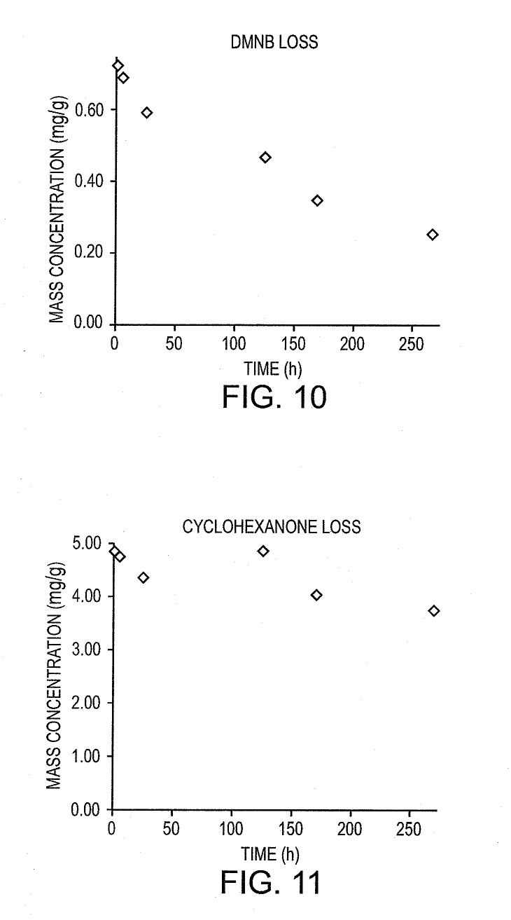

Determining how much of the volatile component(s) remain in the disk as a function of time is important as it defines the useful life of the disk for vapor release. A disk was allowed to absorb the vapors over a ‘consensus’ mixture of four types of the plastic explosive C-4 for 49 days. Two of the known canine odorants were accumulated from the C-4—DMNB, and cyclohexanone. Segments of the disk were exposed to the atmosphere and evaluated at intervals up to 11 days, releasing the odor compounds. The amount remaining in the PDMS segments was determined as a function of exposure time by extracting the PDMS with solvent. The results are shown in FIGS. 10 and 11. Note that after an induction period of about a day, the amount of released vapor over time is quite linear. The release depends on the chemical properties of the components (partition coefficient, vapor pressure, diffusion coefficient) and will not necessarily be the same for all absorbed components. However, the amounts of multiple target odorants may be adjusted through the concentration incorporated into the polymer, following Henry's Law. These type of analyses can be used determine the useful life of the infused disk for odor release and the suitability of the technology for additional forensic applications.

Similar evaluations can be used to evaluate and/or determine stability and lifetime of disks that have been hermetically sealed in flexible wall containers such as, for example, Mylar bags. It has been demonstrated that the highly volatile and unstable compound TATP is stabilized for at least three days at room temperature, whereas the pure compound disappears in hours.

Another important application of the present subject matter relates to canine training aid materials for drugs-of-abuse. Drug infused disks can be evaluated along with the actual drugs to determine the efficacy of this technology. Recognition of the requirements governing the use of controlled substances can be considered. Achieving adequate alert rates will define go-no-go decisions for further development of this infusion technology for canine training.

### Side Apertures

An anatomically correct simulated canine nose was developed by the assignee of the present application that can provide exhalation and inhalation velocities that closely mimic a recent report in the scientific literature, B. A. Craven, E. G. Paterson, G. S. Settles, “The Fluid Dynamics of Canine Olfaction: Unique Nasal Airflow Patterns as an Explanation of Macrosmia,” J.R. Soc. Interface, 2010, (7), 933-943. This system has been used to study the behavior of a vapor compound confined in a training aid container in accordance with the present subject matter using Schlieren optics (which can visualize vapor transport based on refractive index differences of air and vapor). This system has also been used to study effectiveness of training aid canisters in accordance with the present subject matter. For conventional training aid canisters with apertures only in the top, very poor release of vapor is found as the sniffer is moved toward the canister (as a dog would searching for odor). Only when the simulated dog's nose is directly over the canister does any appreciable odor get inhaled. However, when multiple apertures are provided in the sides of the canister (as well as a few in the top), two effects are noted. First, without the simulated sniffing, that canister releases the heavier than air vapor out the sides of the container, drawing replacement air in the top apertures. This provides more scent, i.e. a greater amount of the target agent(s) of interest, for the dog to locate when searching over large areas. Secondly, upon approach of the nose to the canister with simulated sniffing, the side apertures allow vapor to be drawn out of the side apertures with aerodynamic force, where they are subsequently inhaled in a highly effective manner. When the sniffer is located over the canister (as a dog would in a ‘find’) the amount of vapor that is released and inhaled is very large. Accordingly, the use of side or laterally directed apertures is a highly effective means to deliver odors associated with the described delivery system.

Many other benefits will no doubt become apparent from future application and development of this technology.

All patents, published applications, standards, publications, and articles noted herein are hereby incorporated by reference in their entirety.

As described hereinabove, the present subject matter solves many problems associated with previous strategies, systems and/or devices. However, it will be appreciated that various changes in the details, materials and arrangements of components and/or operations, which have been herein described and illustrated in order to explain the nature of the present subject matter, may be made by those skilled in the art without departing from the principle and scope of the claimed subject matter, as expressed in the appended claims.

What is claimed is:

1. A system for selectively storing and releasing one or more target agents, the system comprising:
an enclosure including a wall that defines at least one defined orifice, the enclosure also defining a sealed interior for which the defined orifice provides flow communication between the interior of the enclosure and the enclosure exterior;
a polymeric substrate sized and shaped to be positionable within the interior of the enclosure, the polymeric substrate including a non-crystalline, hydrophobic polymer able to absorb at least one target agent for subsequent storage and/or release from the substrate;
wherein upon infusion of the polymeric substrate with the at least one target agent, and positioning of the polymeric substrate within the interior of the enclosure, the target agent volatilizes from the substrate into a vapor phase in the interior of the enclosure and subsequently flows through the at least one defined orifice thereby exiting the interior of the enclosure.

2. The system of claim 1, wherein the polymeric substrate includes polydimethylsiloxane (PDMS).

3. The system of claim 1, wherein the enclosure has a cylindrical shape and includes a circular end wall that defines the at least one defined orifice.

4. The system of claim 1, wherein the enclosure also includes a selectively positionable gate adjacent the at least one orifice to thereby adjust the size of the opening of the orifice.

5. The system of claim 1, wherein the polymeric substrate is infused with at least one target agent.

6. The system of claim 5, wherein the target agent is representative of at least one of (i) a drug-of-abuse, and (ii) an explosive agent.

7. The system of claim 1, wherein the wall includes a laterally directed region and the at least one defined orifice is defined in a laterally directed region of the wall.

8. The system of claim 5, wherein the polymeric substrate is in the form of a film.

9. A method of selectively providing at least one target agent in vapor phase, the method comprising:
providing a polymeric substrate that includes a non-crystalline, hydrophobic polymer;
infusing the polymeric substrate with at least one target agent;
providing an enclosure defining a sealed interior and at least one defined orifice in a wall of the enclosure;
positioning the polymeric substrate infused with the at least one target agent within the enclosure, whereby the target agent volatilizes from the infused polymeric substrate and flows through the at least one defined orifice of the enclosure, thereby selectively providing the target agent in vapor phase.

10. The method of claim 9, wherein the infusing the polymeric substrate with at least one target agent is performed by combining the at least one target agent with one or more monomers of the polymeric substrate prior to polymerizing the monomers to form the polymeric substrate.

11. The method of claim 9, wherein the infusing the polymeric substrate with at least one target agent is performed by vapor phase transfer from a source material containing the target agent to the polymeric substrate.

12. The method of claim 9, wherein the infusing the polymeric substrate with at least one target agent is performed by contacting the polymeric substrate with the target agent in a volatile solution.

13. The method of claim 9, wherein the infusing the polymer substrate with at least one target agent is performed by absorption from a solution.

14. The method of claim 9, wherein the at least one defined orifice is defined in a sidewall of the enclosure.

15. The method of claim 9, wherein the target agent is selected from the group consisting of (i) accelerants, (ii) agricultural or biological agents, (iii) contraband, (iv) explosives, (v) agents associated with human remains, (vi) narcotics, controlled physiologic substances, or illegal drugs, (vii) agents associated with pests or insects, (viii) other agents of interest, and (ix) combinations of any of (i)-(viii).

16. A method for providing at least one target agent in vapor form representative of a material of interest, the method comprising:
identifying at least one target agent which is representative of a material of interest, the material of interest including the at least one target agent and additional agents;
infusing the polymeric substrate with at least one target agent;
positioning the infused polymeric substrate within an enclosure having a sealed interior and at least one defined orifice in a wall of the enclosure, whereby the at least one target agent vapor transfers from the infused polymeric substrate through the at least one defined orifice of the enclosure thereby providing the at least one target agent in vapor form representative of the material of interest.

17. The method of claim 16, wherein the at least one target agent is representative of a drug-of-abuse.

18. The method of claim 16, wherein the at least one target agent is representative of an explosive agent.

19. The method of claim 16, wherein after infusing the polymeric substrate is free of the additional agents of the material of interest.

20. The method of claim 16, wherein the at least one defined orifice is defined in a sidewall of the enclosure.
